(19) United States
(12) Patent Application Publication
(10) Pub. No.: US 2020/0118770 A1
(43) Pub. Date: Apr. 16, 2020

(54) HYBRID ACTIVE MATERIALS FOR BATTERIES AND CAPACITORS

(71) Applicant: GM GLOBAL TECHNOLOGY OPERATIONS LLC, Detroit, MI (US)

(72) Inventors: Haijing Liu, Shanghai (CN); Zhiqiang Yu, Shanghai (CN)

(21) Appl. No.: 16/471,250

(22) PCT Filed: Jan. 19, 2017
(86) PCT No.: PCT/CN2017/071651

§ 371 Date: Jun. 19, 2019

(51) Int. Cl. H01G 11/50; H01M 10/0525; H01M 4/485; H01M 4/36; H01M 4/587; H01M 4/58; H01M 4/505; H01G 11/62; H01G 11/24; H01G 11/86; H01G 11/32; H01G 11/46

(52) U.S. Cl. CPC H01G 11/50; H01M 10/0525; H01M 4/485; H01M 4/366; H01M 4/587; H01G 11/46; H01M 4/505; H01G 11/62; H01G 11/24; H01G 11/86; H01G 11/32; H01M 4/5825

(57) ABSTRACT

Provided is a particulate electrode material for an electrode of a hybrid battery/capacitor, in which the battery constituent is a lithium-ion battery. The electrode material comprises: a group of hybrid particle structures, each hybrid particle structure consisting of electrode material and capacitor material, each hybrid particle structure being characterized by a core particle composed of active anode material or of active cathode material for a lithium-ion battery, each core particle being covered by a porous shell of smaller carbon particles, the carbon particles being porous and serving as capacitor material in the group of hybrid particle structures, the porosity of the shells of capacitor material particles enabling lithium ions in a selected non-aqueous solution of a lithium electrolyte salt to interact with both the active anode material or the active cathode material of the core particle and the porous carbon capacitor particles of the shell. Also provided is a method of forming hybrid particle structures.

### CROSS-REFERENCE TO RELATED APPLICATION

This application is a continuation-in-part of PCT/CN 2016/084249, filed Jun. 1, 2016, and titled “LITHIUM ION BATTERY AND CAPACITOR HYBRIDIZATION IN MATERIAL AND ELECTRODE LEVEL.” The entirety of the text and drawings of PCT/CN 2016/084249 are incorporated herein by reference.

### INTRODUCTION

The above-referenced PCT application pertains to the incorporation of separate particles, or separate layers of particles, of both lithium ion intercalation/de-intercalation electrode materials (battery materials) and lithium ion adsorption-desorption electrode materials (capacitor materials) into one or both of the respective electrodes of a lithium-based electrochemical cell. The lithium ion processing materials are selected and used as small (micrometer-scale) particles such that the combined active anode materials and the combined active cathode materials of each cell may be capable of both intercalating and adsorbing lithium ions and corresponding anions from a non-aqueous liquid electrolyte. In general, the process of intercalation/de-intercalation occurs throughout the whole volume of the selected battery electrode material. A gram of battery electrode material can usually intercalate a greater amount of lithium ions than are adsorbed on the surfaces of capacitor particles. But the release of lithium ions from battery particles is typically slower than the release of lithium ions from selected capacitor particles. The battery particles are typically capable of producing more energy per gram than capacitor particles, but the capacitor particles release adsorbed lithium ions faster and are typically capable of providing more power per gram than battery particles.

By incorporating predetermined amounts of suitable capacitor materials with separate battery electrode materials in one or both of the anode and cathode of the electrochemical cell, the power level, energy level, and cycle life of a hybrid lithium-ion battery/capacitor may be balanced for its intended use or application. By varying the content of capacitor material mixed with lithium-ion battery material in one or both of the electrodes of each cell, the performance of the battery may be better adapted for varying applications, such as start/stop vehicle engine operation, applications requiring fast charging, shipping-port crane operation, state grid stabilizers, racing cars, etc. Each of these potential applications for lithium-processing electrochemical cells may present different requirements for energy density (Wh/kg) and for power density (W/kg). For many applications it is desired that the electrochemical cell be capable of producing an energy density between 40 Wh/kg and 150 Wh/kg and a power density between 1500 W/kg and 5800 W/kg.

Particles of suitable lithium-ion battery electrode materials and separate particles of suitable capacitor materials are applied to one or both faces of a compatible aluminum or copper current collector sheet (typically a thin foil) as a porous, resin-bonded layer of substantially uniform thickness. A single porous layer of mixed battery and capacitor electrode material particles, also typically mixed with particles of a conductive carbon and coated with a polymeric binder may be bonded to both major surfaces of a current collector member. Or two separate, porous, resin-bonded layers of battery electrode particles and of capacitor electrode particles, one layer overlying the other, each layer with particles of conductive carbon, may be sequentially bonded coextensively to the surface of a suitable current collector.

In general it is preferred that the respective electrochemical capacities of the anode and cathode, one or both containing battery and capacitor electrode particles, provide substantially equal electrochemical power capacities (in mWh or the like). The proportions of the battery electrode particles and capacitor particles in the electrodes may be varied to provide different cell properties but the output capacities of the electrodes are balanced.

There remains a need to prepare further improved hybrid electrode materials providing a combination of battery and capacitor functions within the particulate structures of the materials.

### SUMMARY

Hybrid active electrode particle structures for lithium-ion hybrid electrochemical battery/capacitor cells are prepared in which each particulate structure comprises active electrode material and active capacitor material. A batch or group of hybrid electrode particle structures may be formed with a core particle of anode or cathode material, each core particle having a porous coating (a shell) of smaller formed-in-place particles of capacitor material. The structures of the hybrid core particle enclosed in a shell of particles are such that both the anode or cathode core material and the capacitor material of the shells are accessible to effective contact with a non-aqueous solution of a lithium-containing electrolyte salt. The relative proportions of the active anode or the cathode material with respect to the capacitor material in each particle structure affects the lithium battery (LiB) performance and the capacitor performance (CAP) of the hybrid electrode material particles.

Examples of suitable core-particle anode materials include lithium titanate (Li₄Ti₅O₁₂) or other lithium and complementary-metal containing compounds, and graphite and other carbons that are capable of intercalating and de-intercalating lithium. Examples of suitable cathode materials include graphite, lithium iron phosphate (LiFePO₄), lithium manganese oxide (LiMn₂O₄), a lithium nickel cobalt aluminum oxide (LiNiCoAlO₂) and a lithium nickel manganese cobalt oxide (LiNiMnCoO₂).

Examples of suitable shell capacitor materials include porous carbons with suitable surface properties to adsorb and desorb lithium ions. Such carbons are often prepared by the careful degradation of carbon and hydrogen-containing polymers or other compounds and include, for example, microporous carbon (pore size less than two nanometers), mesoporous carbon (pore size of two nanometers to fifty nanometers), macroporous carbon (pore size greater than fifty nanometers), activated carbon, high surface area carbons, graphene and the like.

A porous shell of smaller porous capacitor particles may be formed on the surface of a core particle of electrode material in different ways, adapted to provide the shell particles of a desired size, surface area, and porosity. The porous shell enables a liquid, lithium-containing electrolyte solution to access both the particle of core electrode material and the porous particles of the shell capacitor material. In a preferred embodiment the core particle of anode or cathode material is of micrometer size and the enclosing shell particles of capacitor material are of nanometer size. The pore size of the capacitor material is selected for the intended application. In many lithium battery/capacitor applications it may be preferred that the porous shell of the hybrid particle structures consist of carbon particles, themselves having pores in the range of 2 to 50 nm (mesoporous) to effectively interact with a non-aqueous lithium-ion containing and transporting electrolyte.

Accordingly, in a specific example, the hybrid material is synthesized by forming (synthesizing) a porous coating (the shell) of mesoporous carbon particles on the surfaces of micrometer size (1 μm-20 μm) core particles of active anode material (e.g., Li₄Ti₅O₁₂ particles) or particles of active cathode material (e.g., LiFePO₄ or LiMn₂O₄). Each micrometer-size core particle of the anode material or the cathode material is coated with a porous shell of porous carbon particles. The porous carbon particles have diameters or largest dimensions in the range of about 10 nm to about 10 and in this example, with compatible pore sizes in the mesopore size range of 2 to 50 nm. Mesoporous carbon particles may be formed by any suitable method. In the following illustrative example, a soft-templating method is used in the synthesis and coating method for preparing a porous shell of mesoporous carbon shell particles on each core particle of an electrode material.

In an illustrative example of a practice of the soft-templating method, micrometer-size particles of an anode material such as lithium titanate (Li₄Ti₅O₁₂) provide the core elements of the hybrid anode/capacitor particle structures. Lithium titanate is often prepared in the form of micrometer size particles with irregular shapes, spherical shapes, cylindrical shapes, tubes, wires, and rods. The soft-templating method is adaptable to the different particle shapes of the starting anode or cathode compounds.

The surfaces of a batch of contained, micrometer-size lithium titanate anode particles are first treated with a solution (e.g., an ethanol solution or other suitable alkanol solvent) of a hydrophobic reagent, such as 1-dodecanethiol. The selected reagent forms a metal-sulfur bond with the titanium atoms at the surfaces of the lithium titanate anode particles (or with other metal atoms in other anode or cathode compounds). The lipophilic sulfur-containing groups formed on the surfaces of the hydrophilic electrode precursor (in this illustration, lithium titanate anode material particles) provide hydrophobic surface sites for the subsequent accommodation of organic, carbon-precursor materials on the surfaces of the electrode particles for the formation of a porous shell of mesoporous carbon particles.

The batch or group of sulfur-modified, hydrophobic surface site-containing lithium titanate particles is then infiltrated with a solution (e.g., ethanol or other alkanol solvent or dispersant) of a relatively low molecular weight, carbon-based polymer such as resol (a phenol-formaldehyde resin with, for example, a molecular weight of less than 500 as measured by GPC) and a tri-block polymer surfactant such as (HO(CH₂CH₂O)₂₀—(CH₃—CH₂—CH₂O)₇₀—(CH₂CH₂O)₂₀H) (commercially available as P123). The polymer molecules of this tri-block copolymer contain a central hydrophobic propyl segment ((CH₃—CH₂—CH₂O)₇₀) and two hydrophilic ((CH₂CH₂O)₂₀) end segments. The relatively low molecular weight phenol-formaldehyde polymer will serve as the precursor carbon-supplying material for the mesoporous carbon capacitor particles. And the tri-block copolymer serves as the soft-template in this synthesis example.

The hydrophobic polymer segment of the tri-block polymer interacts with the hydrophobic sites on the surface of the anode particles and the hydrophilic segments interact with the hydroxyl groups on the resol polymer molecules. Thus, the tri-block polymer molecules disperse the resol molecules and serve to distribute globules of the resol polymer on the surfaces of the lithium titanate anode core particles. The terminal hydroxyl groups and hydrogen groups on the relatively large copolymer molecules assist in this goal. The mixture of sulfur-treated anode particles and liquid resol solution is located in a suitable container to facilitate the evaporation and recovery of ethanol at, for example, 25° C. over a period of six hours. The solvent-free mixture is then further heated at about 100° C. for 24 hours to promote thermosetting of a coating of the resol polymer on the surfaces of the lithium titanate anode particles.

The polymer-coated lithium titanate particles are then heated to about 350° C. in a suitable inert atmosphere to pyrolyze and remove the tri-block copolymer surfactant as carbon dioxide and carbon monoxide. Any residual carbon from the pyrolysis of the P123 may remain with the coating of resol polymer. The coated anode particles are then heated to about 900° C. in an inert atmosphere to carbonize the distributed globules of the resol, organic polymer, resin. This high temperature reaction also removes the sulfur initially formed on the lithium titanate particles.

The resulting carbon particles are thus dispersed as a porous shell of mesoporous carbon particles (2 to 50 nm pore size) on the surfaces of the lithium titanate anode core particles. It is found that the mesopore size range is desirable for effective interaction of the shell-located carbon capacitor particles with a lithium-ion containing electrolyte in the operation of the anode-capacitor hybrid particle structure material. The shell of mesoporous carbon particles on the surfaces of micron-size core particles of active anode or cathode material serves to enhance the dispersion of lithium-containing electrolyte solution in and on the core-shell structures of the battery-capacitor electrode particles for hybrid lithium cells.

The illustrative subject soft-templating method of forming the porous carbon particle shell structure on the lithium-containing metal oxide core materials also offers another opportunity for a variation in the forming of the hybrid particles. Since the soft-templating method uses relatively high temperatures, it may also be practiced to incorporate lithium into metal oxide precursor compounds as the starting core particles. For example, one can start with micrometer size particles of TiO₂ and coat them with porous shells of mesoporous carbon particles by the subject carbon templating method. At the completion of the formation of a mesoporous carbon particle shell on each of the TiO₂ core particles, lithium atoms may be introduced into the TiO₂ cores by depositing lithium hydroxide powder on the surfaces of the material and heating the material to about 900° C. in an inert atmosphere. The result is a group of formed hybrid particles characterized by a lithium titanate core and a porous shell of mesoporous carbon particles.

Thus, a significant family of electrode material core-porous carbon capacitor shell structures is now made available for hybrid electrode materials in hybrid lithium battery/capacitor electrochemical cells.

Other objects and advantages will be apparent from the following detailed descriptions of embodiments of the disclosure.

### BRIEF DESCRIPTION OF THE DRAWINGS

FIG. 1 is a schematic enlarged cross-sectional illustration of a structure of a hybrid battery/capacitor material particle having a core of a micrometer-size particle of electrode material for a lithium-ion battery and a porous shell of smaller porous carbon particles of capacitor material. The structure of the core particles would not necessarily be spherical as illustrated in FIG. 1. In a hybrid anode material, each core particle would be composed of a crystalline compound(s) of active anode material for the battery function of a hybrid battery/capacitor. In a hybrid cathode material each core particle would be composed of a crystalline compound of active cathode material.

FIG. 2 is a flow diagram, schematically illustrating steps of a process of forming a hybrid particle structure of a hybrid material formed by synthesizing a porous shell of mesoporous carbon particles on a core particle of active anode material or a core particle of active cathode material. An initial core particle is depicted schematically in a right-cylindrical shape in FIG. 2A, and progressive changes to the circular side surface and end surfaces of the core particle are schematically illustrated in FIGS. 2B-2E as a shell of mesoporous carbon particles are formed on the surfaces of the core particle.

FIG. 3 is a schematic illustration of an electrode for a hybrid battery/capacitor cell. The illustrated electrode is formed of hybrid particle structures which are resin-bonded to the major faces of a compatible current collector foil. Each hybrid particle structure is formed of a core of a particle of anode or cathode material which is coated with a porous shell of smaller porous carbon capacitor particles. In a typical electrode, the resin-bonded hybrid particle structures may be mixed with a suitable quantity of suitably-sized particles of electrically-conductive carbon.

FIG. 4 is a schematic, cross-sectional side view of (i) an anode current collector foil coated on both major sides with hybrid particle structures, each particle structure having a core of a lithium-ion battery anode material particle coated with a porous shell of smaller porous carbon capacitor particles, and (ii) a cathode current collector foil coated on both sides with hybrid particle structures, each particle structure having a core of a lithium-ion battery cathode material particle coated with a porous shell of smaller porous carbon capacitor particles. The two electrodes are rectangular in shape (not visible in the cross-sectional side view of FIG. 4). The opposing major faces of the anode and cathode are physically separated by a porous rectangular polymer separator layer wound from the full outer surface of the cathode, around one edge of the cathode to fully cover the inner face of the cathode and separate it from the adjoining face of the anode, around the edge of the anode to cover the outer face of the anode. The two electrodes with their hybrid electrode core/capacitor shell particle structures are placed within a closely spaced pouch container. The pouch contains a non-aqueous electrolyte solution which permeates and fills the pores of the separator and of the respective active anode/capacitor hybrid particle structures and cathode/capacitor hybrid particle structures. The respective current collector foils have uncoated tabs extending up from their top sides and through the top surface of the pouch container.

### DESCRIPTION OF PREFERRED EMBODIMENTS

FIG. 1 presents an enlarged schematic cross-sectional illustration of a single hybrid particle structure 10 composed of a core particle 12 of lithium-ion battery electrode material contained within a porous shell 14 of particles of a suitable capacitor material. The core particle 12 is either of anode material composition or of cathode composition for a lithium-ion battery. The shell material 14 of the hybrid particle structure is formed of a suitable capacitor material. Examples of suitable capacitor materials include porous carbon (which may be microporous, mesoporous, or macroporous), activated carbon, and graphene.

An illustrative example of a suitable capacitor material is a porous shell of mesoporous carbon particles. In the example in which mesoporous carbon particles are used, the porous shell 14 of mesoporous carbon particles may be formed by the self-templating synthesis method as summarized above in this specification and described below in this specification.

In other applications, the carbon particles of the porous shell may be formed of microporous carbon particles, macroporous carbon particles, activated carbon particles, or graphene. Microporous carbon particles may be formed or derived from carbide compounds. Macroporous carbon particles may be formed by known hard templating practices and by activating carbon particles by reaction with a strong alkali. Similarly, shells of carbon particles may be activated by reaction with a strong alkali or other suitable activating agent. Porous shells of particles of graphene may be formed on core electrode particles by chemical vapor deposition.

Examples of suitable particulate anode materials include lithium titanate (Li₄Ti₅O₁₂) or other lithium and complementary-metal containing compound. Examples of suitable cathode materials include lithium iron phosphate (LiFePO₄), lithium manganese oxide (LiMn₂O₄), a lithium nickel cobalt aluminum oxide (LiNiCoAlO₂) and a lithium nickel manganese cobalt oxide (LiNiMnCoO₂).

Additionally, in accordance with some embodiments of this invention, particles of a precursor metal oxide, such as TiO₂, may be used as a precursor core particle, and lithium atoms introduced into the core particle after the shell of mesoporous carbon particles has been synthesized.

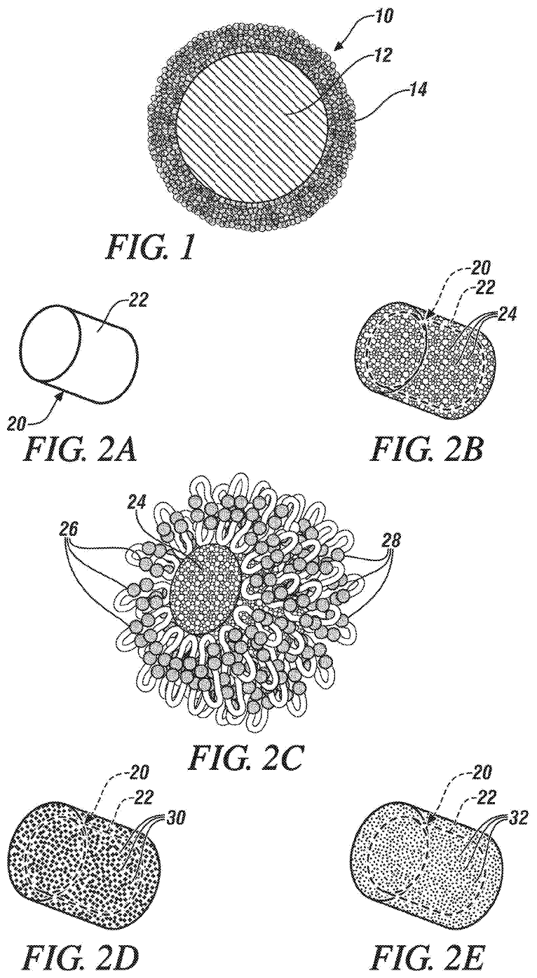

FIGS. 2A-2E present enlarged schematic illustrations of the changes to the surfaces of a starting anode particle, in this example a lithium titanate particle, as a batch of such particles are being processed using a soft-templating synthesis process by which a porous shell of mesoporous carbon particles is formed on each core particle. In FIG. 2A, a core particle 20 of lithium titanate, Li₄Ti₅O₁₂, is illustrated in the form of a right-cylinder to simplify schematic illustration of changes in and on the surfaces of the particle 20 as the synthesis process is performed. Such changes are illustrated schematically on the top and circular side surfaces 22 of right-cylindrical core particle 20

A batch of a suitable quantity of micrometer-size lithium titanate anode particles (an enlarged schematically illustrated representative particle, 20) is treated. Initially, the particles may be placed in a suitable container for treatment of the lithium titanate particles with liquid solutions of specified materials as follows.

The surfaces 22 of each lithium titanate particle 20 (and many of the group of suitable electrode material compounds) are hydrophilic in nature and resist adsorption of a carbon polymer precursor material for the formation of carbon particles on the surfaces 22 (FIG. 2A) of the core particles, like cylindrical particle 20. The particles are initially treated with a solution of a suitable hydrophobic reagent selected to form small hydrophobic sites (schematically illustrated by locations 24 in FIG. 2B) at metal atom locations on the surfaces 22 of each particle 20. Hydrophilic sites also remain on the surfaces 22. A suitable hydrophobic reagent is 1-dodecanethiol which may be dissolved in ethanol and applied at room temperature (e.g., about 20°-25° C.) to the surfaces of each lithium titanate anode particle in the batch being processed. This reagent, with its thiol constituent, forms a metal-sulfur bond with titanium atoms situated at or near the surface of the anode particles (or with other metal atoms in other anode or cathode compounds). A sufficient quantity of the 1-dodecanethiol solution is used to form the hydrophobic metal-sulfur bonds 24 at reactive metal sites on the surfaces 22 of the anode particles. The reaction is completed in an hour or so. The reactive solution is drained or filtered from the anode particles, and the surfaces of the particles may be washed with pure ethanol or the like. In FIG. 2B, the circles 24 on the cylindrical surfaces 22 of the lithium titanate particle are intended to schematically illustrate the many closely-spaced locations on the surfaces 22 of the core particle at which hydrophobic metal-sulfur sites have been formed among a remaining field of the original hydrophilic sites on the surfaces 22 of each lithium titanate particle 20.

The batch or body of sulfur-modified lithium titanate particles is then infiltrated with an ethanol solution of a relatively low molecular weight resol (a phenol-formaldehyde carbon-based polymer resin) and a surfactant, a tri-block copolymer such as P123 (HO(CH₂CH₂O)₂₀—(CH₃—CH₂—CH₂O)₇₀—(CH₂CH₂O)₂₀H). As stated above, the molecules of this tri-block copolymer contain a central hydrophobic propyl segment ((CH₃—CH₂—CH₂O)₇₀) and two hydrophilic ((CH₂CH₂O)₂₀) end segments. This amphiphilic polymer serves as a “soft” template for connecting the resol polymer molecules to the hydrophobic sites 24 on the hydrophilic/hydrophobic surfaces 22 of the lithium titanate core particles. The hydrophobic polymer segment interacts with the hydrophobic sites 24 on the surfaces of the anode particles and the hydrophilic segments interact with the hydroxyl groups on the resol polymer molecules. As schematically illustrated in FIG. 2C, the hydrophobic blocks of the tri-block polymer 26, interact with dispersed globules 28 of the resol polymer, to distribute the polymer globules on the previously-formed hydrophobic surface areas 24 of the surfaces 22 of the anode particle 20. The top surface of anode core particle 20 is left uncovered in FIG. 2C for purposes of illustrating the hydrophobic surface sites 24 being coated with the resol resin, which is the precursor of the mesoporous carbon particles to be formed) on the anode particles. The terminal groups on the relatively large resol copolymer molecules assist in this goal.

The mixture of sulfur-treated anode particles and liquid resol solution is then placed in a suitable container or vessel to enable the evaporation and recovery of the ethanol solvent. The evaporation of the ethanol may be accomplished at substantially room temperature (e.g., 25° C.) over a period of, for example, six hours. The solvent-free mixture is then heated in air at about 100° C. for 24 hours to promote thermosetting of a coating of the resol polymer on the surfaces 22 of the anode particles 20.

The coated particles are then heated under nitrogen at a rate of about 1° C./min to about 350° C. so as to pyrolyze and vaporize the tri-block copolymer surfactant. The resol-containing and adhering surfaces of the lithium titanate core particle are now coated with resol polymer material as represented schematically as polymer globules 30 in FIG. 2D. There may be some residual material from the surfactant polymer and some sulfur remaining on the anode core particle surfaces at this stage of the shell-forming process.

The coated anode particles are then heated under nitrogen at a rate of about 5° C./min to a temperature of about 900° C. to carbonize the distributed globules of the organic polymer resol resin. Residual sulfur is removed. The resulting carbon particles are dispersed as a shell of mesoporous carbon particles (2 to 50 nm pore size) 32 (FIG. 2E) on the surfaces 22 of the lithium titanate anode particles 20. The hybrid anode core 20 with its enclosing porous shell 32 of mesoporous carbon particles is illustrated schematically in FIG. 2E. The thickness of the formed shell of mesoporous carbon capacitor particles is typically in the range of about 100 nm to about 200 nm.

The specific surface areas (S_{BET}) and pore size can be measured by the Accelerated Surface Area and Porosimetry System (ASAP). The specific surface areas (S_{BET}) may be calculated by the Brunauer-Emmett-Teller (BET) method using the adsorption branch in a relative pressure range from 0.04 to 0.2. The pore sizes (Dp) may be derived from the adsorption branches of isotherms using the Barrett-Joyner-Halenda (BJH) model.

The carbon particles have diameters or largest dimensions in the range of about 10 nm to about 10 μm, which can be measured by scanning electron microscopy (SEM) or Transmission electron microscopy (TEM). The particle size may be measured by a Particle size analyzer.

The porous shell of mesoporous carbon particles on the surfaces of micron-size particles of active anode or cathode material serve to enhance the dispersion of lithium-containing electrolyte solution in and on the core-shell structures of the battery-capacitor electrode particles for hybrid lithium cells. And the deposited shell of carbon particles serves to contribute the capacitor function to each hybrid particle. The same basic process may be used to form hybrid particles having cathode material cores and shells of mesoporous carbon capacitor particles as opposing electrodes in a hybrid battery/capacitor construction.

As described, the soft-templating method uses relatively high temperatures. It may also be practiced to incorporate lithium atoms into metal oxide precursor compounds as the starting core particles. In other words, a lithium metal oxide compound is synthesized in the core particle following the formation of the shell of porous carbon particles. For example, one can start with micrometer size particles of TiO₂ and coat them with mesoporous carbon particles by the subject carbon templating method. At the completion of the formation of a mesoporous carbon particle shell on each of the TiO₂ core particles, lithium atoms may be introduced into the TiO₂ cores by depositing lithium hydroxide powder on the surfaces of the material and heating the material to about 900° C. in an inert atmosphere. The result is a group of formed hybrid particles characterized by a lithium titanate core and a shell of mesoporous carbon particles.

The described soft-templating method of forming porous shells of mesoporous carbon particles is a preferred method of forming the hybrid particle structures of this disclosure. The soft-templating method readily accomplishes the formation of a porous shell of mesoporous carbon particles on core particles of a selected anode material or a selected cathode material. But in other applications, the carbon particles of the porous shell may be formed of microporous carbon particles, macroporous carbon particles, activated carbon particles, or graphene. Microporous carbon particles may be formed or derived from carbide compounds. Macroporous carbon particles may be formed by known hard templating practices and by activating carbon particles by reaction with a strong alkali. Similarly, porous shells of carbon particles may be activated by reaction with a strong alkali or other suitable activating agent. Porous shells of particles of graphene may be formed on core electrode particles by chemical vapor deposition.

A suitable quantity of anode/capacitor hybrid particles or cathode/capacitor hybrid particles may then be mixed as a slurry in a solution or dispersion of a polymer binder material. The binder may, for example be polyvinylidene difluoride polymer dissolved in N-methyl-2-pyrrolidone (NMP). A mixture of selected hybrid core/shell particles and conductive carbon particles are mixed and slurried in the binder solution. The wet mixture is then carefully spread, in one or more applications, as a thin porous layer onto one or both of the intended surfaces of a suitable current collector foil, for example an aluminum current collector foil. The solvent, or liquid dispersant, is evaporated, or otherwise removed, to leave the porous layer of hybrid core/shell particles, resin-bonded to each other and to the surface of the metallic current collector foil.

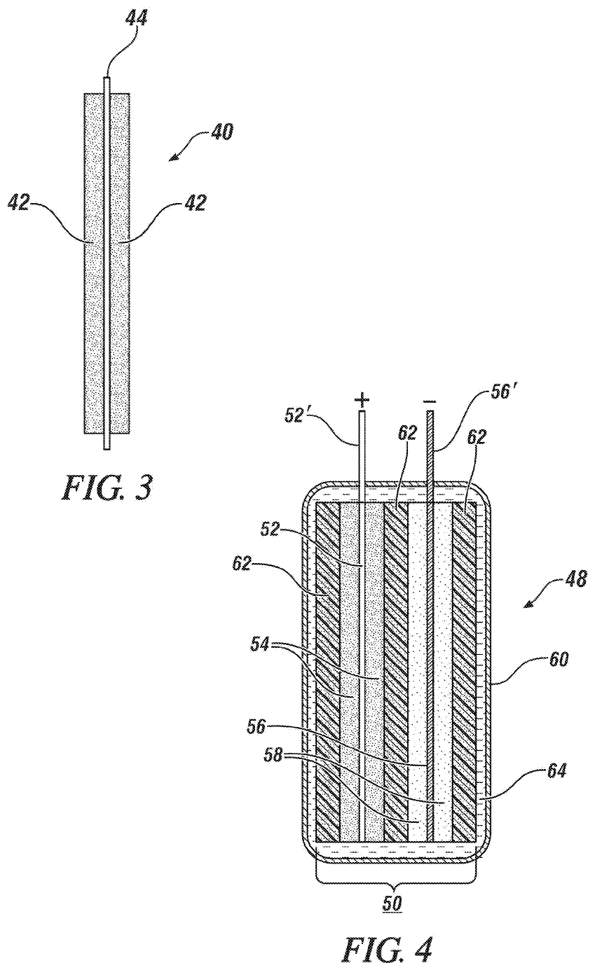

FIG. 3 is a side, elevational view of an anode 40 having a porous layer 42 of hybrid particle structures of anode material particle core/carbon capacitor shell structure, resin-bonded to each major side surface of a copper current foil 44. Each hybrid anode particle structure comprises a core particle of suitable lithium-containing anode composition and a porous shell of mesoporous carbon capacitor particles. As stated, the hybrid electrode particles are often mixed with a suitable portion of conductive carbon particles and with a binder resin. The mixture is resin-bonded as a porous electrode/capacitor particulate layer to one or both faces of the current collector foil. The hybrid electrode often has a rectangular shape and is sized for its intended application. The thickness of the current collector foil is often in the range of about five to fifteen micrometers. The thickness of the resin-bonded porous layer of anode/capacitor material particle structures is often in the range of about fifty to one hundred fifty micrometers. An opposing electrode using hybrid particle structures of a cathode core material with a covering shell of mesoporous carbon capacitor particles is usually formed with a like or compatible shape and dimensions.

FIG. 4 presents a simplified, schematic, cross-sectional side view of an assembly 48 of a single cell combination 50 of hybrid lithium-ion battery and lithium-ion adsorbing capacitor electrode particles assembled into a polymer-coated, aluminum foil pouch 60. The cell 50 comprises a cathode formed of a cathode current collector foil 52 coated on both major sides with a porous layer 54 of hybrid particle structures, each particle structure being formed with a core particle of cathode material enclosed in a shell of porous carbon capacitor particles. The hybrid particle structures may be mixed with conductive carbon particles and a resin bonder to form the porous cathode layers 54. The top portion of current collector foil is an uncoated tab 52′ (indicated as positively charged) extending through the top of pouch 60 and is used for electrical connections with other cells or electrodes. The cathode is lithiated during cell-discharge.

Cell 50 also comprises an anode formed of an anode current collector foil 56 coated on both sides with a porous layer 58 of hybrid particle structures, each hybrid particle structure is formed of a core particle of anode material enclosed in a shell of porous carbon capacitor particles. The hybrid particles may be mixed with conductive carbon particles and a resin bonder to form the porous anode layers 58 on the anode current collector foil 56. The top portion of anode current collector foil 56 is an uncoated tab 56′ (indicated as negatively charged) extending through the top of pouch 60 and is used for electrical connections with other cells or electrodes. The anode is de-lithiated during cell-discharge.

The two electrodes are rectangular in shape (not visible in the side view of FIG. 4). The opposing major faces of the anode and cathode are physically separated by porous rectangular polymer separator layer 62 which may be wound from the full outer surface of the cathode, around one edge of the cathode to separate the adjoining face of the anode and the cathode, around the edge of the anode to cover the outer face of the anode. The two electrodes with their hybrid electrode particles are placed within a closely spaced pouch container 60. The pouch 60 contains a non-aqueous electrolyte solution 64 which permeates and fills the pores of the separator 62 and of the respective active anode and cathode coating layers 54, 58 of resin-bonded hybrid particle structures. The respective current collector foils 52, 56 have uncoated tabs 52′, 56′ extending up from their top sides and through the top surface of the pouch container 60.

The hybrid anode/capacitor particle structures and hybrid cathode/capacitor particle structures may be prepared by any suitable method. A preferred method for the preparation of mesoporous carbon particle-containing shells on electrode material core particles is the soft-templating process described above in this specification.

The above specific examples serve to illustrate practices of forming the hybrid particle electrode structures of this disclosure and not to limit the scope of the following claims

What is claimed is:

1. Particulate electrode material for an electrode of a hybrid battery/capacitor in which the battery constituent is a lithium-ion battery; the electrode material comprising:
a group of hybrid particle structures, each hybrid particle structure consisting of electrode material and capacitor material, each hybrid particle structure being characterized by a core particle composed of active anode material or of active cathode material for a lithium-ion battery, each core particle being covered by a porous shell of smaller carbon particles, the carbon particles being porous and serving as capacitor material in the group of hybrid particle structures, the porosity of the shells of capacitor material particles enabling lithium ions in a selected non-aqueous solution of a lithium electrolyte salt to interact with both the active anode material or the active cathode material of the core particle and the porous carbon capacitor particles of the shell.

2. Particulate electrode material as stated in claim 1 in which the core particles in the group of hybrid particle structures are composed of active anode material for a lithium-ion battery.

3. Particulate electrode material as stated in claim 1 in which the core particles in the hybrid particle structures are composed of active cathode material for a lithium-ion battery.

4. Particulate electrode material as stated in claim 2 in which the active anode material is lithium titanate.

5. Particulate electrode material as stated in claim 3 in which the active cathode material is composed of at least one of lithium iron phosphate, LiFePO₄ and lithium manganese oxide, LiMn₂O₄.

6. Particulate electrode material as stated in claim 1 in which the core particles of the hybrid particle structures have maximum dimensions in the range of one micrometer to twenty micrometers and the porous carbon particles of the shells of the hybrid particle structures have maximum dimensions in the range of ten nanometers to ten micrometers.

7. Particulate electrode material as stated in claim 1 in which the hybrid particle structures are bonded as a porous layer to a surface of a current collector foil, the porous layer being permeable to a non-aqueous electrolyte solution of a lithium electrolyte salt.

8. Particulate electrode material as stated in claim 1 in which the porous carbon particles of the porous shell have pore sizes that are characterized as one of micropores, mesopores, and macropores

9. Particulate electrode material as stated in claim 1 in which the porous carbon particles of the porous shell have pore sizes that are characterized as mesopores.

10. A method of forming hybrid particle structures, each hybrid particle structure containing both electrode material and capacitor material for an electrochemical cell having a combination of lithium-ion battery properties and capacitor properties, the method comprising:
reacting hydrophilic surfaces of particles of a metal oxide or metal phosphate compound with an alkane-thiol compound to form hydrophobic sulfur-containing sites on the surfaces of the particles of the compound, the metal oxide or metal phosphate compound being selected to function as an anode material or cathode material for a lithium-ion battery; then
coating the surfaces of the particles with a mixture of (i) a co-polymer surfactant, composed of both hydrophilic polymer segments and hydrophobic polymer segments, and (ii) a hydroxyl-group-containing, carbon-based polymer to coat the sulfur-containing sites on the surfaces of the particles; then
heating the particles to remove the surfactant and sulfur, while retaining the polymer coating on the surfaces of the particles; and
further heating the particles to pyrolyze and carbonize the polymer coating to leave a group of hybrid particle structures, each characterized by a porous shell of mesoporous carbon particles on a core particle of the anode material or the cathode material.

11. A method of forming hybrid particle structures of electrode material and capacitor material as stated in claim 10 in which the alkane-thiol compound is 1-dodecanethiol.

12. A method of forming hybrid particles structures of electrode material and capacitor material as stated in claim 10 in which an alkanol solution of the alkane-thiol compound is reacted with the hydrophilic surfaces of the particles of a metal oxide or metal phosphate compound to form hydrophobic sulfur-containing sites on the surfaces of the particles, and residual alkanol solution of the 1-dodecanethiol is removed from the particles at the completion of the reaction.

13. A method of forming hybrid particle structures of electrode material/capacitor material as stated in claim 10 in which the copolymer surfactant has hydrophobic (—CH₃CH₂CH₂O—) segments and hydrophilic (—CH₂CH₂O—) segments.

14. A method of forming hybrid particle structures of electrode material/capacitor material as stated in claim 10 in which the hydroxyl-group-containing, carbon-based polymer is a resol polymer.

15. A method of forming hybrid particle structures of electrode material/capacitor material as stated in claim 10 in which a alkanol solution of a co-polymer surfactant, composed of both hydrophilic polymer segments and hydrophobic polymer segments, and a hydroxyl-group-containing, carbon-based polymer is used to coat the sulfur-containing sites on the surfaces of the particles, and the alkanol solvent is evaporated when the particles are subsequently heated to remove the surfactant and sulfur.

16. A method of forming hybrid particle structures of electrode material/capacitor material as stated in claim 10 in which a alkanol solution of a co-polymer surfactant, composed of hydrophobic (—CH₃CH₂CH₂O—) segments and hydrophilic (—CH₂CH₂O—) segments, and a hydroxyl-group-containing, resol polymer is used to coat the sulfur-containing sites on the surfaces of the particles, and the alkanol solvent is evaporated when the particles are subsequently heated to remove the surfactant and sulfur.

17. A method of forming hybrid particle structures of electrode material/capacitor material as stated in claim 10 in which the metal oxide or metal phosphate compound contains lithium.

18. A method of forming hybrid particle structures of electrode material/capacitor material as stated in claim 10 in which the metal oxide or metal phosphate compound contains lithium and a second metal.

19. A method of forming hybrid particle structures of electrode material/capacitor material as stated in claim 10 in which the metal oxide or metal phosphate compound consists of lithium titanate as an anode material or one of lithium iron phosphate or lithium manganese oxide as a cathode material.

20. A method of forming hybrid particle structures of electrode material/capacitor material as stated in claim 10 in which the metal oxide or metal phosphate compound does not contain lithium, and lithium is subsequently introduced into the core compound by adding lithium hydroxide powder to the formed shells of mesoporous carbon particles on the formed hybrid particles and heating the hybrid particles to react lithium with the metal oxide or metal phosphate compound to form a lithium-containing anode or cathode material.
